(19) United States
(12) Patent Application Publication
(10) Pub. No.: US 2004/0017507 A1
(43) Pub. Date: Jan. 29, 2004

(54) Motion compensation of images

(76) Inventor: John Christopher Clayton, BUCKINGHAMSHIRE (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/415,612

(22) PCT Filed: Nov. 5, 2001
(86) PCT No.: PCT/GB01/04894

(30) Foreign Application Priority Data
Nov. 3, 2000 (GB) 0026846.6

(51) Int. Cl. H04N 7/12

(52) U.S. Cl. 348/407.1

(57) ABSTRACT

Motion compensation of a sequence of image fields (0-5) is carried out in the frequency domain using phase correlation (10) between corresponding picture areas of a pair of time-spaced, input fields (1,4) to produce a set of motion-vector estimates that are used for filtering the relevant areas of each field (1;4) of the pair by interpolation (11;12) with the corresponding area of its preceding and following input-fields (0,2;3,5) of the sequence, to produce a frame-approximation to that field (1;4) through combination of the individually-filtered areas. The filtering in each case involves respective application (24-26) of weighting coefficients to corresponding spatial-frequency components of the relevant picture areas of three fields, and summation (28) of the weighted components, the coefficients being calculated or selected (27) according to the motion-vector estimate associated with each picture area. Repetition of the phase-correlation step (13) using the frame-approximations refines each motion-vector estimate for repeating the three-field interpolation processes (14,15) to derive better frame-approximations. Transformation from the frequency to spatial domain (34) takes place after two or more reiterations, or when convergence is reached for all constituent picture areas.

### FIELD OF THE INVENTION

This invention relates to methods and apparatus for motion compensation of images.

BACKGROUND OF THE INVENTION

The invention is especially concerned with methods and apparatus for motion-compensated filtering and processing of sampled moving images such as, for example, television pictures.

The standard 525- and 625-line formats for television picture-image sequences use interlaced scanning. This halves the number of scan lines in each field of the image sequence, thereby discarding half the information necessary to define each image in the vertical direction fully. For example, after vertical blanking is accounted for, all European 625-line television pictures or frames are composed of 575 scan lines. However, the frame is transmitted as two separate fields of 287 or 288 lines, one field consisting of the odd-numbered lines and the next the even-numbered. As the two fields in general depict different moments in time, it follows that the only opportunity to assemble easily the two fields into one complete frame occurs when the televised scene is completely static. It is desirable to be able to recreate the missing lines in the more general case of an image sequence depicting motion, so that output pictures with full vertical resolution can be generated, but the conversion of each input field into a corresponding frame with full vertical resolution poses a difficult problem

It has been recognized for some time that the process of reconstruction of the pictures for optimum image reproduction in television and other image methods and systems requires the use of techniques that compensate for motion in the images. Also, it has been recognized that the use of motion compensation enables other commonly-used processes, such as standards conversion and noise reduction, to be executed with superior results as compared with simpler fixed or adaptive interpolation methods. Motion-estimation and compensation techniques are also of central importance to video compression systems.

Compensation of the motion associated with various moving objects in picture sequences first requires an accurate measurement of the corresponding motion vectors; a process generally known as motion estimation. It is one of the objects of this invention to provide a more accurate estimate of these motion vectors than is obtained using the prior art methods of motion estimation on their own.

### SUMMARY OF THE INVENTION

According to the present invention, there is provided in one aspect a method, and in another aspect apparatus, for motion-compensated filtering of a sequence of input images, wherein the images are transformed into representations in a frequency-domain in which spatial-frequency components are represented in amplitude and phase, weighting coefficients are applied to corresponding spatial-frequency components of successive image-representations, and the resultant weighted components are submitted after combination together to the inverse transform to derive filtered, output images in the spatial domain.

The weighting coefficients used for each spatial-frequency component may be calculated as a function of the respective spatial frequency and a motion vector of the input images. More especially, the weighting coefficients may be chosen to pass one temporal frequency and attenuate one or more others, these frequencies being calculated as a function of said spatial frequency and a motion vector in order to create a progressively-scanned output frame from an input image sequence. The input image sequence may consist of interlaced fields or progressively-scanned frames and may contain undesirable signal components resulting from the presence of a modulated color subcarrier in the input signal and/or random noise. The weighting coefficients may be chosen to create a filtered output frame substantially free of such components and/or noise and may be modified in order to produce a filtered output representative of an arbitrary point in time.

In certain circumstances two estimates of the motion vector may be indicated. Which of these two possibilities is valid, may be derived by reflecting the vertical component of the converged vector result in the nearest critical value and selecting either said converged vector result or the final converged vector result that is achieved after said reflection, according to the relative absolute differences of the vertical component of the two converged solutions from said critical value.

The method and apparatus according to the invention differ from the prior art in that the motion compensation is carried out in the frequency domain rather than in the spatial domain. One advantage of this approach is a potential reduction in the amount of computation required when compared with the prior art, but a greater benefit is the opportunity to integrate both motion estimation and compensation into one combined reiterative process. The combined process takes place in the frequency domain.

Although motion compensation has been conventionally carried out in the spatial domain using linear interpolation, some prior art techniques for motion estimation have used spatial-domain methods and others frequency-domain methods. Broadly speaking, there are three techniques in common use for motion estimation, namely: (1) block or feature matching algorithms; (2) spatio-temporal gradient analysis; and (3) phase correlation; the first two are conducted entirely in the spatial domain, but the third calculates a correlation surface from spatial frequency components.

Conventionally, one of the above techniques is used to estimate motion vectors in some area of the moving image sequence and at some point within the sequence. The resulting motion vectors are then applied to a motion-compensated interpolator pixel-by-pixel, having used some matching technique to test the vectors for their validity at each point being interpolated. Whichever technique of estimation is used, there are found to be difficulties in analyzing the motion contained within image sequences that originate in interlaced format. This renders any de-interlacing process at best difficult and at worst impossible. Even when a motion vector can be found, there may be two apparently-feasible solutions, causing difficulty in deciding which is the valid one. It has been found that use of the method and apparatus according to the present invention generally avoids this difficulty.

### BRIEF DESCRIPTION OF THE DRAWINGS

Methods and apparatus for motion-compensated filtering of images, in accordance with the present invention will now be described, by way of example, with reference to the accompanying drawings, in which:

FIGS. 1 and 2 are illustrative of aspects of the technique of phase correlation as this is used in the prior art and in the methods and apparatus of the present invention;

FIGS. 3 and 4 are further illustrative of characteristics associated with phase correlation generally, for the purposes of preliminary explanation applicable to the methods and apparatus of the present invention;

FIGS. 5a to 5e show by FIG. 5a an original frame of an image that includes movement, by FIG. 5b a frame that has been reconstructed to reproduce the original using a first value of vertical motion, by FIG. 5c an indication of the difference between the original and reconstructed frames of FIGS. 5a and 5b, by FIG. 5d a frame that has been reconstructed to reproduce the original using a second value of vertical motion, and by FIG. 5e indication of the difference between the original and reconstructed frames of FIGS. 5a and 5d;

FIG. 6 is a schematic representation of a method of motion compensation of images according to the present invention;

FIG. 7 is a schematic representation of the motion compensation apparatus according to the invention using the method of FIG. 6;

FIGS. 8a to 8d show test images applicable to four different circumstances, for the purpose of explanation of the effects of aliasing;

FIGS. 9 to 12 are graphical representations used for the purpose of further explanation in connection with aliasing;

FIGS. 13a to 13d show a sequence of four image frames to which reference is made by way of description of application of the method and apparatus of the invention to de-interlacing;

FIG. 14 provides a graphical representation of a spatial-frequency component of the four frames of FIGS. 13a to 13d;

FIGS. 15 and 16 are graphical representations illustrative of temporal-frequency components over a sequence of image fields;

FIGS. 17 and 18 are graphical representations illustrative of a filtering process applied according to the invention to circumstances illustrated in FIGS. 15 and 16;

FIGS. 19a to 19c shows a three-field sequence from which the frame of FIG. 5b is reconstructed;

FIGS. 20a and 20b illustrate an effect to which reference is made in the description;

FIGS. 21a and 21b illustrate, respectively, a window function and the result of its application, by way of illustration of image processing referred to in the description;

FIG. 22 is illustrative of overlaid tile arrays referred to in relation to further description of image processing;

FIGS. 23a and 23b illustrate a transition function in two-dimensions and one-dimension respectively, referred to in the description;

FIG. 24 is a graphical representation illustrative of a described effect of convergence experienced in image processing; and

FIGS. 25a to 25d are filter response characteristics obtained in applications of the method of the invention.

### DETAILED DESCRIPTION OF THE INVENTION

The method of the present invention as described herein uses the known technique of phase correlation as part of its integrated system of motion estimation and compensation. As already stated, this technique is commonly used for measuring the motion of objects in image sequences such as television pictures. In order to localize the measurement of motion vectors, a small area of the picture may be selected from two or more neighboring input fields, to allow a comparison of the picture content within this area to be made. There are several considerations that dictate the optimum size for this area, referred to in this description as a tile. A typical tile size may be 64 pixels×64 lines, before any window functions are applied, although larger or smaller tile sizes may also be desirable. The tile coordinates may be the same for all the input images in the sequence, or they may be relatively shifted, in order to track a moving object in the image sequence.

The process of phase correlation first requires the picture tiles to be transformed into the frequency domain using the Discrete FourierTransform (DFT); there are several well-known techniques for efficiently performing this transform. The resulting frequency-domain representations of the tile area within two or more neighboring input fields are then used to determine the predominant motion vectors that apply to objects within the field of view of the tile. The theoretical basis of the process of phase correlation is covered in many texts, but essentially relies upon the phase relationship between similar spatial frequency components in two transformed images. The amplitudes and phases of the various spatial frequency components are represented as complex values in the transformed arrays. The phase increment between the two images that are being compared, is first calculated for each spatial frequency by dividing the complex values found in the two transformed image arrays, one by the other. The amplitudes of all the spatial frequency components of the resulting array are then normalized to unity. An inverse transform of this normalized array yields a correlation surface that displays a peak (or peaks) shifted from the origin by an amount indicative of the predominant motion vector (or vectors) within the tile.

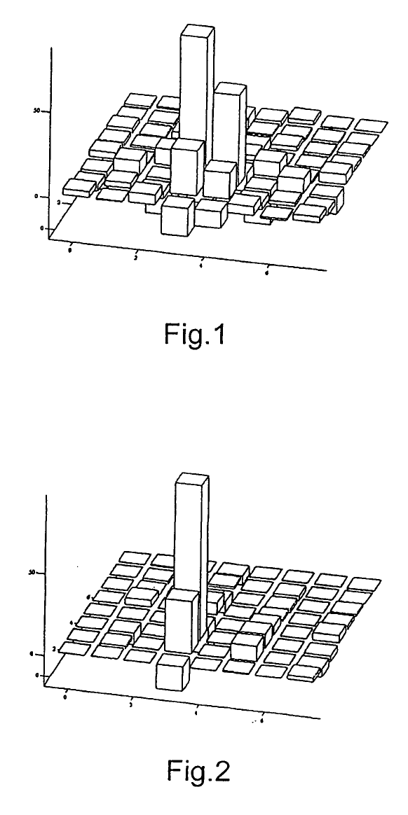

It is possible to use more than two input fields in order to increase the accuracy of the result, for example by combining several phase correlation surfaces using different input field spans. However, there is a fundamental limitation to the accuracy with which vertical motion vector components can be determined when processing interlaced input formats. This arises because the correlation surface itself takes on the characteristics of an interlaced raster; every second row of data is zero, as is every second row of input picture information due to the missing lines in the interlaced field format. This effect is illustrated in the plots of FIGS. 1 and 2 which are of correlation surfaces derived from neighboring images, with the vertical dimension plotted left to right and the horizontal dimension front to back. FIG. 1 shows the surface obtained when the input images are presented as full frames (that is to say, with no missing lines due to interlacing), and FIG. 2 shows the corresponding result obtained when the same input images are presented in interlaced format.

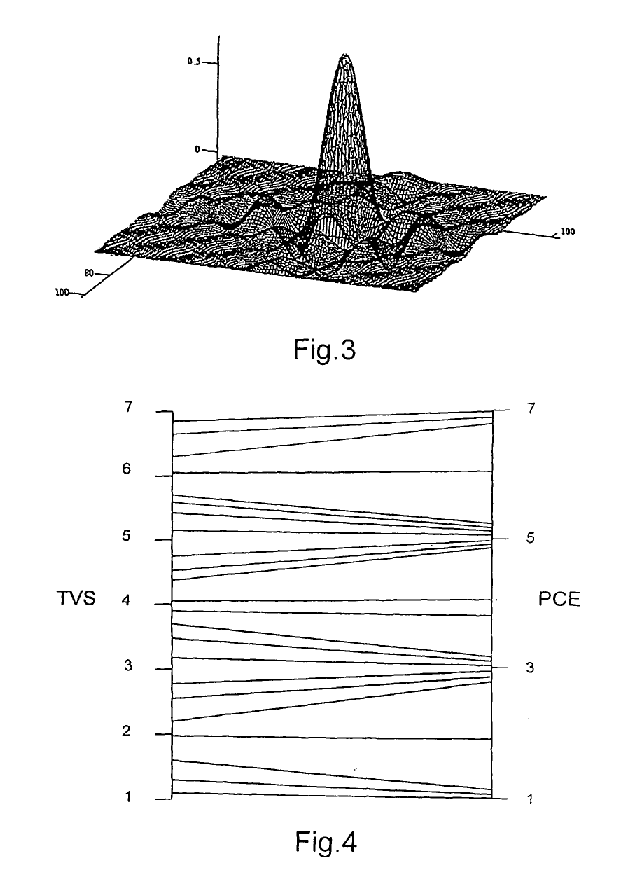

The peaks generally take the form of displaced two-dimensional ‘sinc’ functions, as illustrated in higher resolution in FIG. 3, but as demonstrated by FIGS. 1 and 2, the phase correlation process returns a result sampled at pixel and line rates that are relatively coarse. In order to locate the precise position of the peak from these arrays, it is necessary to use a peak-location algorithm that gathers its evidence from the array of sample values surrounding the ‘invisible’ peak. As shown by FIG. 2, the relative sizes of the peaks in the rows that are present, still gives a reasonable indication of the horizontal position of the peak and, therefore, a reasonable estimate of the horizontal motion vector component. However, the missing rows render the vertical component very hard to estimate with any accuracy.

When such an array is used, it is found that the peak that is located does indeed provide an accurate assessment of the horizontal component of the motion vector, but that the returned vertical component is generally inaccurate. As illustrated in FIG. 4, there is a tendency for the true vertical velocity (TVS) to be represented by the phase-correlation estimation process (PCE) as nearer to certain integral values than is truly the case, to the effect that the vertical component of the motion vector can be considered ‘attracted’ to the nearest ‘critical’ vertical velocity. These values of vertical velocity are termed ‘critical’ because they represent speeds of vertical motion at which the scan lines of the successive interlaced fields fall on the moving image at the same vertical positions on each field, relative to the image. In other words, at these vertical speeds of motion, the moving image is scanned with no more vertical resolution than would be obtained from a single field. It is an impossible task in these cases to reconstruct a full-resolution frame since none of the detail that exists in the unscanned areas between the lines is ever revealed. Frame reconstruction becomes increasingly difficult as these critical vertical velocities are approached. It also becomes increasingly difficult to determine accurately the vertical component of motion at speeds close to these critical values.

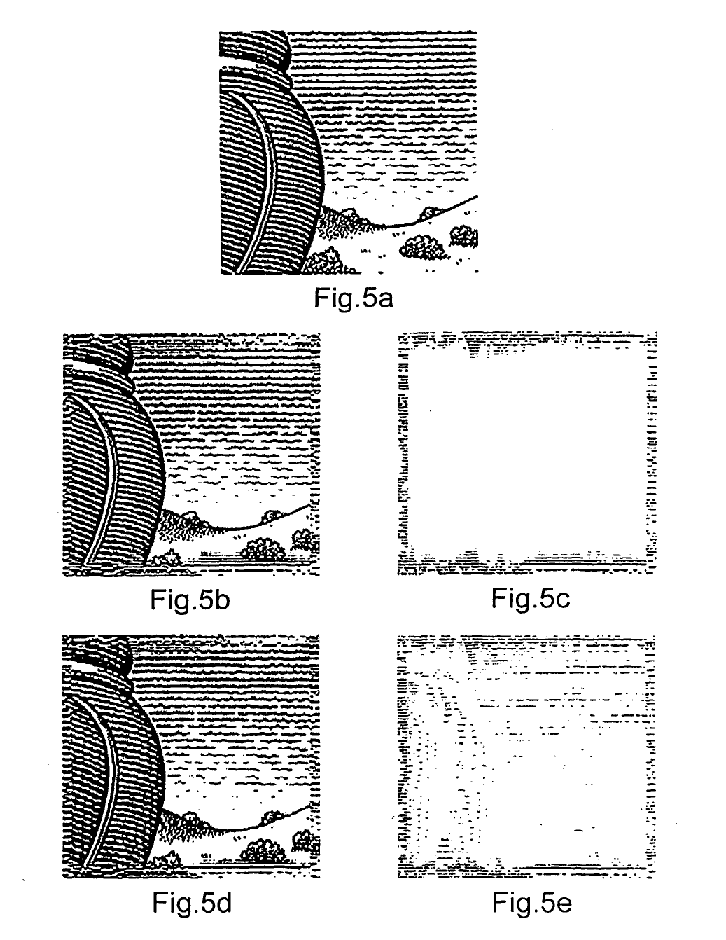

It may be shown that image sequences with near-critical vertical motion speeds may still be reasonably accurately reconstructed, provided that an accurate estimate of the vertical components of the motion vector is available. By way of illustration, FIG. 5a shows an example of an original frame and FIG. 5b the result of reconstructing it from three successive interlaced fields, in circumstances where the image is moving with a vertical velocity component of 7.1 frame lines per field, this being very close to the critical velocity of 7 frame lines per field. The difference (that is to say, the error) between the original and the reconstruction is shown in FIG. 5c; the difference frame reflects the fact that these images are not windowed (the relevance of this is discussed below). The errors around the border of FIG. 5b are to be expected, since they result from the motion of the image into and out of the frame, but otherwise the rendition of the central area is reasonably good.

By contrast, when the reconstruction is carried out using a vertical velocity value of 7.2 frame lines per field, as in the case represented in FIG. 5d (an error of only 1.4%) the reconstructed frame is degraded. The difference between the reconstructed frame at FIG. 5d and the original frame of FIG. 5a is shown in FIG. 5e, and comparison between the difference-representations of FIGS. 5c and 5e indicates the degree of image degradation.

This demonstrates the need for accurate motion vectors if the full benefit of the disclosed method of motion compensation is to be obtained. However, as already stated, accurate vertical vector components are not easily found from the use of conventional phase correlation techniques. Given that phase correlation is known to work well when full frames are processed and that motion compensated interpolation can produce frames from fields, the possibility of using reconstructed frames as the input to the phase correlation process suggests itself. The difficulty is that motion-compensated frame reconstruction only works when the motion vectors are known. The problem, therefore, seems to require the solution before it can be solved.

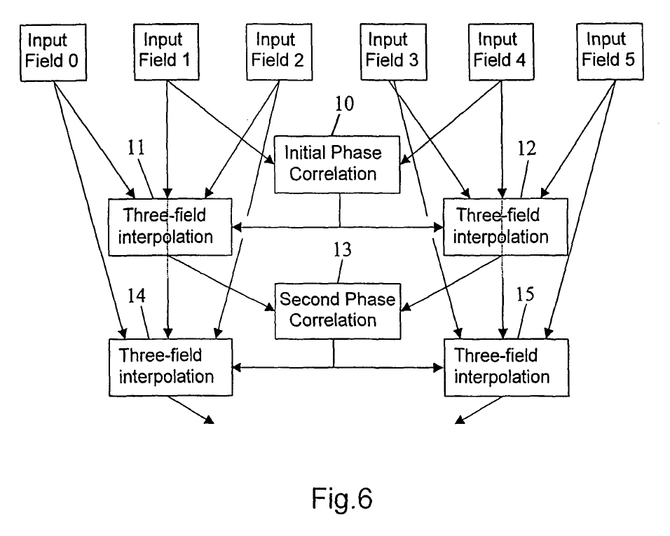

The problem is tackled in accordance with the method of the present invention utilizing the reiterative process illustrated in FIG. 6.

Referring to FIG. 6, the method involves the following process stages:

1. From the input sequence of raw image fields, identified in FIG. 6 as input fields 0 to 5, use relevant area(s) or ‘tiles’ from two of the fields of the sequence, in this case input fields 1 and 4, that are separated from one another in the sequence by three (in this example) field-periods, to produce an initial estimate of the motion vector for that tile using a conventional phase-correlation step 10. This produces a fairly accurate result for the horizontal component but the estimate of the vertical component is generally inaccurate due to the effects of the interlaced input format.

2. Use this initial estimate of the motion vector derived in step 10 to filter the relevant tiles of the two fields 1 and 4 that have been correlated. The filtering is carried out in the frequency domain on the raw fields 1 and 4 in three-field interpolation process steps 11 and 12 respectively (three is a preferred number, but a larger number may be used). In step 11, interpolation of field 1 is with fields 0 and 2, and in step 12, interpolation of field 4 is with fields 3 and 5. Steps 11 and 12 produce first approximations to respective frames to replace the two raw fields 1 and 4.

3. The phase-correlation step 10 of stage 1 is now repeated in a second phase-correlation step 13 using the frame-approximations derived in stage 2 to derive a second, refined estimate of the motion vector.

4. The refined estimate of the motion vector derived in stage 3 is used in three-field interpolation steps 14 and 15 which repeat the steps 11 and 12 of stage 2. This produces more-accurate frame-representations of input fields 1 and 4.

5. The more-accurate frame-representations of input fields 1 and 4 are now used to derive representations of even greater accuracy, firstly by submitting them to a further repetition of phase-correlation step 10 to derive increased refinement of the motion vector, and then by their use in further repetition of the three-field interpolation steps 11 and 12 using the increasedly-refined motion vector.

The process may be continued by repetition of stage 5 using the frame representations derived to provide progressively greater accuracy, until there have been a predetermined number of reiterations, or, alternatively, some measure of convergence has been achieved. It has been found that two or three reiterations normally produce sufficiently accurate results, but as convergence is easily detected, this state may alternatively be used to terminate the process.

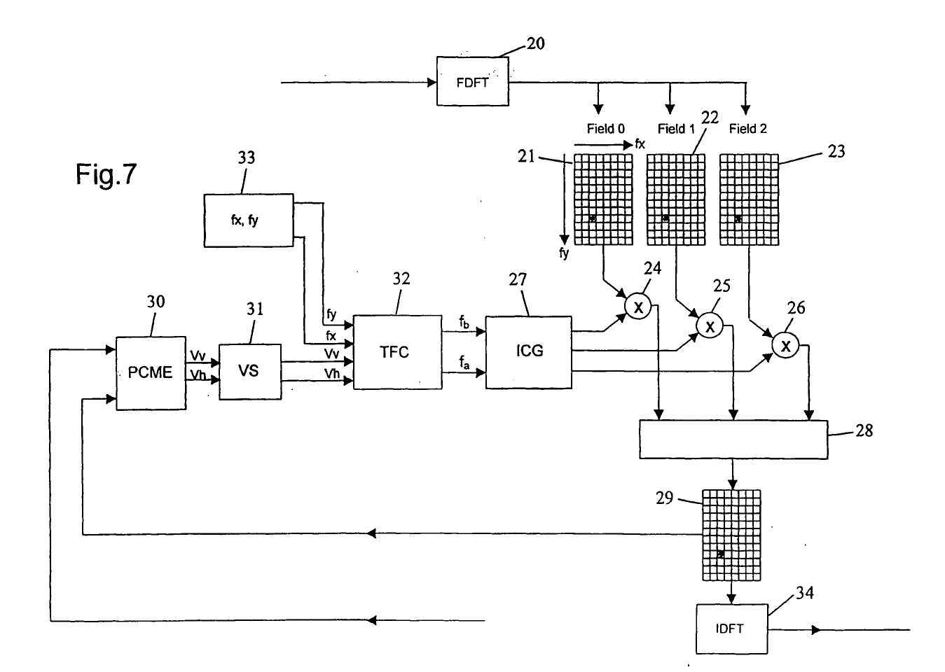

The method of the invention illustrated in FIG. 6 is conducted entirely in the frequency domain, and is implemented in apparatus (hardware and/or software operation) as illustrated schematically in FIG. 7.

Referring to FIG. 7, the input sequence of frame tiles or fields in the spatial domain are mapped into the frequency domain by a forward DFT unit 20. The pixel brightness values of three successive frames 0 to 2 are transformed into arrays of complex numbers which represent the amplitude and phase of each constituent frequency component of the relevant image. These arrays of complex numbers are entered into buffers 21 to 23 in sequential progression. The complex numbers representing the frequency components from corresponding spatial frequencies (fx,fy) of the three fields 0 to 2 in buffers 21 to 23 are read out to complex-number multipliers 24 to 26, respectively, for processing with weighting coefficients supplied by a complex-number interpolation-coefficient generator 27. The outputs from the three multipliers 24 to 26 are summed in a complex-number adder 28 to derive a complex-number frequency array in a buffer 29. The multiplication and summing operations are carried out on different spatial-frequency components in turn.

The frequency array initially entered in the buffer 29 is unchanged from that of field 1 entered in the buffer 22, and complex-number representations of the spatial-frequency components (fx,fy) of the array are supplied serially (or in parallel) from the buffer 29 as one of two inputs to a phase-correlation motion estimator 30. The other input to the estimator 30 is of complex-number representations of spatial-frequency components (fx,fy) of a frequency array representative of field 4 of the input image sequence, which is stored in a buffer (not shown) paired with the buffer 29, and the contents of which are derived in the same manner and using the same weighting coefficients as for field 1, from the three fields 3 to 5 of the input image sequence. The estimator 30 operates in accordance with the method stage 1 described above with reference to FIG. 6 to derive and supply to a vector store 31, initial estimates of the horizontal and vertical motion-vector components Vh and Vv, respectively, of the motion vector in each tile.

The vector store 31 supplies representations of the components Vh and Vv to a temporal frequency calculator 32 in conjunction with representations of the relevant spatial frequency coordinates fx and fy from a sequencer unit 33 for each tile. As later explained, the calculator 32 in response derives alias and baseband temporal frequency representations fₐ and f_{b}, respectively, and these are applied to the generator 27 for calculation of the complex-number interpolation coefficients supplied to the multipliers 24 to 26. These weighting coefficients, based on the initial estimate of the motion vector in the vector store 31, are effective through the multipliers 24 to 26 and adder 28 to implement the three-field interpolation filtering of method stage 2 described above with reference to FIG. 6, and produce frequency arrays in the buffer 29 and that paired with it, representative respectively of more-accurate replacements for the raw fields 1 and 4.

The weighting coefficients may be stored in a pre-calculated look-up table which is addressed by the two temporal-frequency variables, fₐ and f_{b}. The resolution with which the temporal frequencies are quantised and the word-length of the coefficients themselves, define the size of the table; a finely-quantized table allows more accurate interpolation but increases the storage requirement. The process has been tested with a 768×768 table, although it may be possible to reduce this size without compromising the interpolation accuracy to any great extent. In the current implementation, the coefficients are calculated and stored as floating-point values, although this degree of accuracy may not be warranted in practice; instead of storing the coefficients, they may alternatively be calculated ‘on the fly’ as they are needed.

The complex-number representations of the frequency components of the more-accurate arrays are supplied to the phase-correlation estimator 30 to derive a refined estimate of the motion vector in accordance with stage 3 described above with reference to FIG. 6. This refined estimate as stored in the vector store 31 for each tile, is then utilized through the calculator 32 and the generator 27 to derive fresh weighting coefficients for the filtering process carried through with the multipliers 24 to 26, resulting in more-accurate representations of fields 1 and 4 in accordance with method stage 4 described above with reference to FIG. 6.

The apparatus continues reiteratively to produce in buffer 29 and the buffer paired with it, even greater accuracy of representation of fields 1 and 4, in accordance with method stage 5 described with reference to FIG. 6. When further refinement of accuracy is terminated, whether by number of reiterations or convergence, the frequency arrays derived are communicated to an inverse DFT 34 unit for transformation back into the spatial domain to provide the output motion-compensated video.

When all the vertical motion speeds for all the areas or ‘tiles’ contained within an image are plotted over several reiterations, the initial values are often seen to be bunched around the critical speeds. On subsequent reiterations, the bunches spread out as the vertical speed of each individual tile converges to a point close to its true value.

It is known to estimate the brightness of new pixels that are not spatially coincident with the pixels in the input picture sequence, by linear interpolation in the spatial domain using suitable aperture functions. As a general matter there are several applications that require pixels to be created in new positions; for example, de-interlacing, picture resizing and standards conversion.

The most general form of interpolation process used for television applications is three-dimensional, in that it finds intermediate pixel values in the horizontal, vertical and temporal dimensions. The object is to create the output pixel value that would have been produced by the source, had it been working in the destination standard, or in the case of a picture resizer, had the resizing been done optically by the camera lens. In reality, this goal is very difficult to achieve. It is in pursuit of this ideal that motion compensation was added to the earlier fixed and motion-adaptive interpolation techniques.

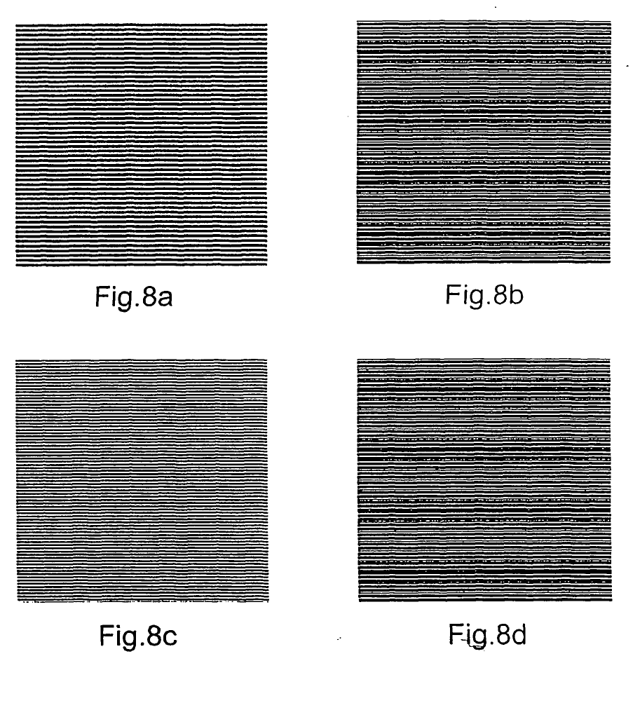

The four test images shown in FIGS. 8a to 8d illustrate the phenomenon of aliasing that is well known in image processing and sampled signal processing in general. The images of FIGS. 8a and 8b relate to a vertical frequency (fy) of 52 (cycles per picture height), scanned in full frame (256 lines) and single field (128 lines) formats respectively, whereas those in FIGS. 8c and 8d correspondingly relate to full frame and single field formats respectively, for a vertical frequency of 76 (cycles per picture height). The sampling (Nyquist) rate required for reconstruction of the original image signal is necessarily twice the highest component frequency contained in that signal, and this requirement is met in both cases when scanning is at the full frame rate, namely 256 lines in this example, but only for a vertical frequency fy of 52 when scanned with the 128 lines of a single field.

The result shown in FIG. 8d of scanning the higher frequency with only 128 lines, is in fact indistinguishable from that of FIG. 8b produced by scanning the lower frequency. By looking at the data contained in the 128 scan lines, it is not possible to tell whether the original value of vertical frequency was 52 or 76, and so it is, therefore, not possible to reconstruct the original signal unambiguously.

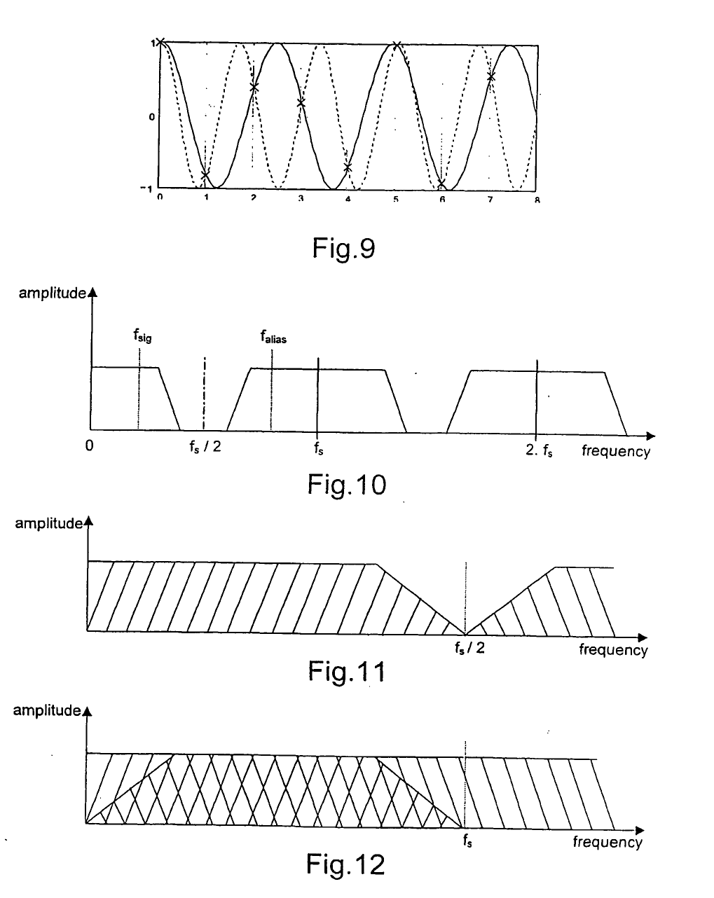

The two frequencies of FIGS. 8a to 8d are plotted as the solid and dotted sinusoids in FIG. 9 with the sampling points indicated. The sampled values are seen to be identical for both signals. If it is known that the bandwidth of the original signal is within the Nyquist limit associated with the sampling frequency, then the higher frequency could not have existed and so there is no ambiguity.

Sampling theory also indicates that the sampled signal may be viewed in the frequency domain as an infinite number of repetitions of the baseband spectrum. These repeat spectra are centered on multiples of the sampling frequency as indicated in FIG. 10, where only positive frequencies are shown. Although the spectrum extends to infinity in this fashion, the interval between zero frequency and the sampling frequency fₛ is the only area of interest for the present purposes.

The dotted lines in FIG. 10 indicate the location in the frequency domain of a single signal frequency f_{sig} and the associated alias frequency fₐₗᵢₐₛ that is created by the sampling process.

fₐₗᵢₐₛ=fₛ−f_{sig}

From this relationship, it may be seen that the lower-frequency part of the first repeat spectrum is a reflection of the baseband spectrum from zero in fₛ. As the signal frequency increases from zero, the corresponding alias frequency descends from the sampling frequency eventually to meet the signal frequency at ½fₛ (the highest signal frequency that can be reproduced).

In practice, there has to be some finite gap between the top of the baseband spectrum and the bottom of the first repeat spectrum to allow the sampled signal to be reconstructed into a continuous signal. This process of reconstruction is done by filtering the infinite spectrum so that only the baseband signal remains.

In the case of interlaced format video, aliasing will often exist in the input fields due to the fact that each field is a vertically ‘undersampled’ frame.

The vertical frequency spectrum of an image scanned as a full frame is illustrated in FIG. 11. This assumes a flat spectrum up to a vertical frequency of approximately 80% of the ‘frame Nyquist frequency’ ½fₛ, this being the highest frequency supported by the number of scan lines in the full frame. The lower part of the first repeat spectrum is also shown.

The spectrum of the same image, scanned as a single field, that is to say, by half the number of frame lines, is shown in FIG. 12. As stated above, the first repeat spectrum is the baseband reflected in the sampling rate. As the sampling rate has now been halved, the baseband and first repeat spectrum completely overlap, other than in the regions where the response rolls off.

Due to the overlapping of the baseband and reflected baseband spectra, each discrete frequency in the field-scanned spectrum contains potential contributions from two different vertical frequencies in the original image. In the example given earlier, the two frequencies chosen were fy=52 and fy=76. There were 128 field scan lines and so the corresponding alias frequencies were:

128−52=76 and 128−76=52

Therefore, the presence of either of these vertical frequencies in the original image will give rise to both frequencies in the field-scanned spectrum. It is impossible to determine which of the two frequencies was present in the original image from the evidence contained in the field-scanned spectrum.

Despite the difficulty of extracting the necessary information from individual fields, it is possible in many cases to reconstruct accurately complete frames using several neighboring fields depicting moving images. This would intuitively seem to be possible, when the relative position of the successive field scan lines to the moving image is considered. Except in cases of critical vertical speeds, the scan lines will generally fall on different vertical positions relative to the image detail on successive fields, thereby building up evidence of the detail that is lost in each single field.

It is easy to see how to build up a frame from two successive fields when the image is stationary, but not at all obvious how best to combine the information from several fields when the image exists in different positions in each field. However, this has been done in the spatial domain to varying degrees of accuracy using a technique known as ‘motion compensated interpolation’. This technique is an extension of earlier linear interpolation methods that were not motion compensated.

Linear interpolation in the spatial domain allows new pixels to be created from an existing set of near neighbors using weighted addition of their brightness values. The weights assigned to each of the contributing pixels are derived from ‘aperture functions’ which take account of the offset of the new pixel from those contributing to its value. This offset may have vertical, horizontal and, in some cases, temporal components. When motion compensated interpolation is used, the choice of contributing pixels and the associated aperture functions must also take account of the local motion in the image sequence. In the most demanding applications, it may be necessary to use extremely complex aperture functions covering several hundred contributing pixels from three or more successive images, in order to obtain optimum results.

The present invention provides a new approach to motion-compensated interpolation that offers a less onerous path to obtaining the desired results. Instead of performing the interpolation process in the spatial domain using aperture functions as described above, it is carried out in the frequency domain, after having transformed the input fields or frames. The new method allows existing motion estimation techniques to give improved results, particularly when interlaced input sources are used.

Frequency domain methods of motion estimation such as phase correlation, described above, require a forward DFT to be carried out on the input image as part of the normal process. Therefore, when the new method is integrated with these existing techniques, the forward DFT does not represent an additional workload.

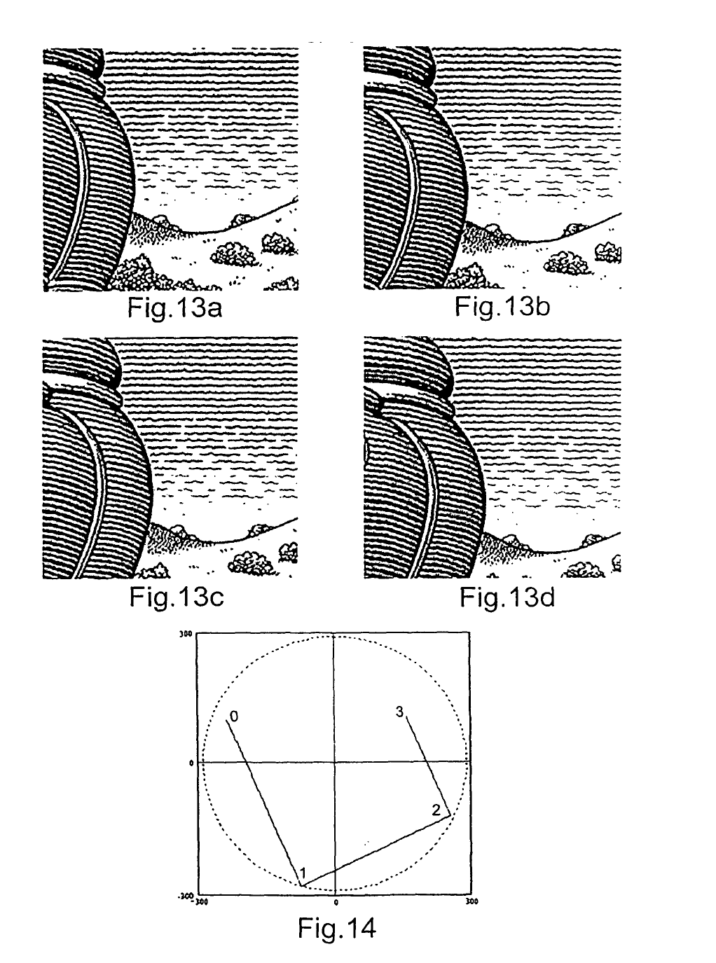

In order to show how the problem of de-interlacing may be approached from a frequency domain perspective, the progress of a particular spatial frequency component through four successive input fields will now be considered. In this regard, FIGS. 13a to 13d show a sequence of four images scanned as complete frames, and FIG. 14 shows the four values of the same spatial frequency component found in these four frames, plotted in the complex plane, joined with straight lines. This plot describes the progress of the spatial frequency given by fx=2, fy=4.

It is to be noted that the increment in phase from one frame to the next would be the same for any other image and is dependent only on the spatial frequency and the motion vector. The theoretical increment in phase from one frame to the next, resulting from a horizontal and vertical displacement δy for frequency fx, fy is given by:

φ=360.(fx.δx+fy.δy)

where δx, δy are in picture width and height units respectively, fx and fy are in cycles per picture width and height respectively, and φ, the phase increment from frame to frame, is in degrees.

Therefore, although the phase and amplitude of each spatial frequency component cannot be predicted (since these define the image), the way each component proceeds from frame to frame may be predicted with some degree of accuracy. This implies that, if the motion vector is known, it should be possible to filter the image by filtering each array of complex values representing each single spatial frequency component over successive images.

The phase increment per field or frame, φ, for a given motion vector and spatial frequency, is known, and is the phase increment the array would be expected to exhibit. However, when arrays that are derived from real image sequences are considered, there are departures from this ideal, particularly when the images are captured as fields in interlaced format.

In the earlier discussion of the vertical spectrum of an image scanned as a single field, it was shown that each spatial frequency component in the field-scanned spectrum contains potential contributions from two different vertical frequencies in the original image due to aliasing. The vertical frequency fₐₗᵢₐₛ of the component in the original image that causes this potential interference is known from the earlier expression:

fₐₗᵢₐₛ=fₛ−f_{sig}

When dealing with both positive and negative frequencies, the ‘conjugate’ vertical frequency in the case of an image with 256 frame lines, is found as:

fy_{—}conj=fy−128

Thus, a frequency bin with a high positive vertical frequency such as (fx=24, fy=100) will receive potential contributions from components in the original image, of frequencies:

(fx=24, fy=100) and (fx=24, fy=−28)

The contributions are described as ‘potential’ since it is not known whether either or both components are present at any appreciable amplitude. Neither are their phases known, since both amplitude and phase are dependent on image content.

The second ‘conjugate’ frequency component produces a result in this frequency bin which is indistinguishable from the first when viewed in a single transformed field. However, its behavior is different when its effect on the array of complex values is viewed across several transformed fields. This is because the interference has come from an original image frequency with a different value of fy and will, therefore, produce a different temporal frequency.

The precession of phase of a single spatial frequency component through a succession of fields defines its temporal frequency (ft). When dealing with frame-scanned images, evidence of a single temporal frequency for each spatial frequency, in other words, a point that rotates at fairly constant amplitude with a constant phase increment per frame, could be expected to be seen.

When the transformed images are scanned as interlaced fields, the array of points corresponding to several consecutive fields can be thought of as the wanted array that would result from transformed full frames, plus an unwanted array resulting from the effects of aliasing due to scanning the images as fields.

The characteristic that may be used to separate the wanted component from the unwanted component is, therefore, temporal frequency. The temporal frequency of the full-frame ‘baseband’ component f_{b} is:

f_{b}=fx.Vh+fy.Vv

where f_{b} is in cycles per field, Vh is the horizontal component of the motion vector in image width per field, Vv is the vertical component of the motion vector in image height per field, fx is in cycles per image width, and fy is in cycles per image height.

Similarly, the temporal frequency of the ‘alias’ component fₐ is:

fₐ=ft_{—}conj(fx.Vh+fy_{—}conj(fy).Vv)

where: fy_conj(fy) equals (fy−fy_max) for positive values of fy, and (fy+fy_max) for negative values of fy; and the additional modification ft_conj(ft), which is used to account for the effects of the oscillating line structure of the interlaced format, equals (ft−0.5) for positive values of ft, and (ft+0.5) for negative values of ft.

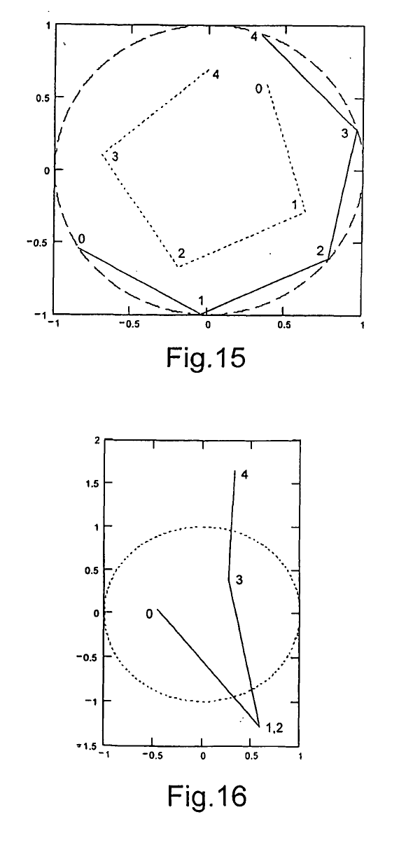

Given that there are two signals of unknown amplitude and phase but of known temporal frequencies, a method is required for their separation. For the purpose of explanation of the method used, reference will now be made to FIGS. 15 and 16.

FIG. 16, which is illustrative of the two components over five fields with field numbers shown adjacent to each field's associated complex value for this particular spatial frequency, shows idealised versions of hypothetical, wanted ‘baseband’ and unwanted ‘alias’ arrays that will be added together as a result of transforming images that were scanned as interlaced fields. FIG. 16, on the other hand, shows the combined array obtained by adding each individual field contribution of the two arrays together (as happens in practice):

In FIG. 15, the solid trace is of unity amplitude and increments its phase by 54.5 degrees per field in an anti-clockwise (positive) direction. The inner dotted trace is of amplitude 0.7 and decrements its phase by 81.8 degrees per field. This is, therefore, a negative temporal frequency and proceeds in a clockwise direction with increasing field number. The unit circle is shown for reference.

As illustrated in FIG. 15, showing the two arrays separately, the length of the vector joining one point to the next is roughly equal in both arrays. Therefore, when the directions of the vectors are opposite, as they are between fields 1 and 2, the combined array shows virtually the same complex value for these two fields, whose points are therefore almost coincident. This combined array of points is filtered according to the method of the invention in such a way as to remove the unwanted ‘alias’ array whilst retaining the ‘baseband’ array. The process is carried out for every spatial frequency, so as to recreate the original full-frame images by transforming the filtered frequency arrays back into the spatial domain.

The filtering process as described above uses the combined array value at the field to be reconstructed plus two neighboring fields' values as its filter ‘taps’. As a general rule, more accurate results may be obtained by using contributions from a larger number of fields, especially when the vertical motion is close to certain critical speeds as discussed below. However, since this is a motion-compensated method, the use of a larger number of fields implies that the more distant fields must be shifted by proportionally larger amounts.

Pictures can be divided down into smaller tiles to be transformed into the frequency domain to allow different motion vectors to be found and applied to different areas of the picture. The use of a larger number of fields reduces the useable area of the tile, due to invalid image information being shifted in from the edges. In addition, the various objects in a picture seldom move in a manner that can be accurately modelled as a pure translation with uniform velocity. Furthermore, objects pass in front of other objects, obscuring them from view. Often, all these effects together conspire to cause difficulties in using information from more than three or four fields. A good compromise between quality of the reconstructed image and the aforementioned effects may be obtained by using three fields for the filtering process, that is to say, the field to be de-interlaced together with the one before and the one after.

The compensation of the motion that exists in the input sequence gives rise to edge effects in the output tile, as is evident from FIG. 5b. In general, only a central area of the output tile is displayed, the hard edges of the tile being softened by a window function. The final image is reconstructed from an array of these soft-edged tiles.

The contents of the center field's frequency bin contains a contribution from both the wanted and unwanted array. To approach the value that would have been derived by transforming the full-frame version of that field's image, the contribution from the ‘alias’ array is to be canceled.

Referring again to consideration of FIG. 15, showing the two arrays as separate plots, the inner dotted trace represents the unwanted alias component.

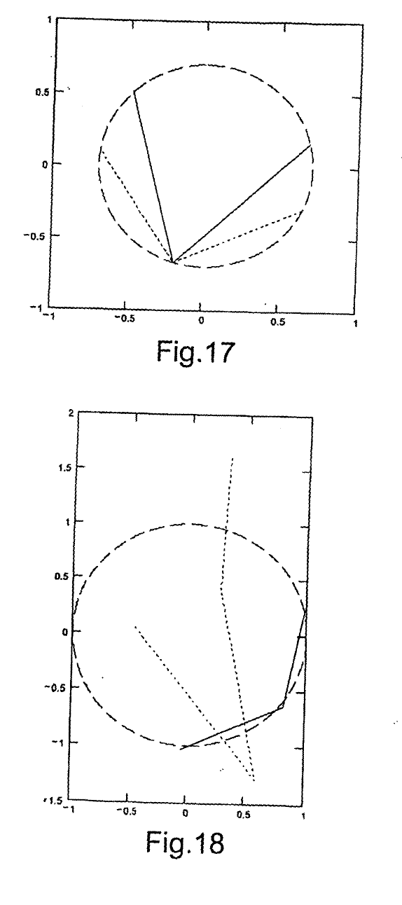

It is possible to design a linear-phase ‘FIR’ (finite impulse response) filter to reject particular frequencies, with three or more taps; the rejection ‘notch’ frequency may be defined more precisely as more taps are added. With only three taps, the possibilities are limited, but a filter may be constructed to cancel any unwanted temporal frequency component by phase-shifting the outer field contributions to make the three field values sum to zero. FIG. 17 shows such a filtering process applied to the central three values of the above example, to produce a filtered center value; the raw and filtered values are shown by the dotted and solid traces, respectively. The two outer original alias array values have complex coefficients applied that have the effect of rotating one clockwise and the other anti-clockwise about the origin by exactly the amount required to situate the three values 120 degrees apart. When the two modified values are added to the unmodified centre value it may be seen, by symmetry, that the three contributions sum to zero. This simple filter, therefore, has zero response at this particular temporal frequency.

However, it must be remembered that this filter is to be applied to the array of combined values and, therefore, must not distort the wanted ‘baseband’ array value. Applying the same set of coefficients to the centre three fields of the ‘baseband’ array will generally result in a gain change, depending on the difference between the two frequencies to be respectively accepted and rejected. The coefficients may then be scaled up or down to correct the ‘baseband’ gain to unity.

The filter described above uses one of many possible sets of coefficients that will reject one frequency and pass the other unmodified. The filter coefficients that have been adopted for three-field interpolation are actually of the following form:

$$[ \begin{matrix}B ( {f}_{b} , {f}_{a} ) \cdot exp ( j \cdot 2 π \cdot {f}_{p k} ( {f}_{b} , {f}_{a} ) ) \\ 0.5 \\ B ( {f}_{b} , {f}_{a} ) \cdot exp ( - j \cdot 2 π \cdot {f}_{p k} ( {f}_{b} , {f}_{a} ) )\end{matrix} ]$$

where: f_{b} and fₐ are, as previously indicated, the baseband and alias temporal frequencies respectively, fₚₖ is an offset version of the average of these two frequencies, and real coefficient B is adjusted as a function of f_{b} and fₐ.

Since there are five fields shown in the earlier example of the combined baseband and alias array, there are enough fields to allow the centre three values to be filtered using the above three-field coefficients. These three central values when filtered in this way produce the result shown in FIG. 18. In FIG. 18 the solid trace represents the filtered result and shows the original three central values of the five-field ‘baseband’ array, as expected.

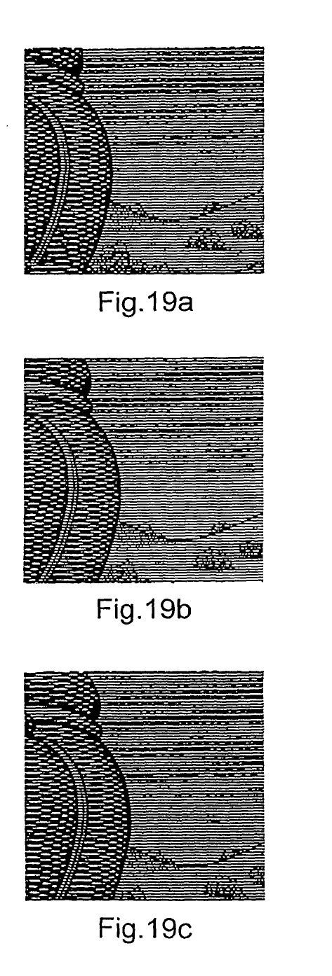

Applying this method of temporal frequency filtering to the three-field sequence shown in FIGS. 19a to 19c, yields the reconstructed frame shown in FIG. 5b.

The complex coefficients that are applied to the transformed input fields, as described above, effectively shift the two outer images of the sequence to align with the center image whilst performing the filtering process described above. This allows all three input fields to contribute to the output image in a coherent fashion. It is relatively straightforward to apply such shifts to an image in the frequency domain, by applying a phase shift to each frequency component in accordance with the earlier expression. It is, therefore, also possible to modify the coefficients to place the final image in any desired position within the tile to match any of the original fields, or at any other intermediate position. For example, it is possible to create a filtered image from a sequence of three input images such as that in FIGS. 19a to 19c, to coincide with the position of the image in any one of the fields shown.

In the reiterative process illustrated in FIG. 6, the two filtered images compared at each motion estimation stage are filtered with a coefficient set that applies no shift to input fields 1 and 4, allowing their true relative position to be measured; it is to be noted that no inverse transform need be performed at this stage. When convergence is achieved, a modified set of coefficients may be applied to the stored frequency arrays to create shifted versions of the filtered images. This may be done, for example, to create an output frame that is coincident with the one of three input fields. Another coincident output frame may be created from a different group of three input fields. These results may then be compared with the original field and the better match selected for output at each picture point.

It is also necessary to create an output image for every motion vector that is found within the area to be reconstructed. The reiterative motion estimation process is capable of accurately identifying more than one vector in an area of analysis, provided the evidence of the various motion vectors is reasonably equally balanced and not masked by the presence of a much ‘stronger’ vector. By using suitable motion estimation algorithms, it is then possible to extract useful vectors which may then be used to reconstruct output images, each image correctly compensating one element of motion in the area in question. It is often also necessary to use motion vectors that are identified in nearby areas of analysis to construct further output images that correctly compensate other motion vectors that are not easily identified. There may, therefore, be several contenders for the final output image. In general, because different points in the image are moving with different motion vectors, some points will be correctly reconstructed in one output image while other points are best portrayed in another. The use of images constructed from ‘early’ and ‘late’ groups of input fields allows the appropriate image to be chosen for an output pixel situated in a position where consistent information may not be available in one of the groups of fields. This occurs, for example, in the case of concealment of detail due to an object passing in front of the area of interest. Often, the obscured detail is consistently portrayed in only the early or late group of input fields.

The best match may be selected with reference to a single input field, although there is, of course, no way of verifying that the information that has been created for the missing lines is, in fact, valid. It also possible to create alternative sets of coefficients for use in the interpolation process that allow a ‘matching’ image to be created when the inverse transform is performed. This image indicates areas of match for a particular motion vector across the contributing fields by assuming a flat mid-range value and indicates a mismatch where other values are present.

The result shown in FIG. 5b displays a significant degree of error when compared with the original frame. Most of the deviation is close to the edges of the frame but there is also some distortion that spreads into the central area. This is a particularly difficult frame to reconstruct, due to the amount of vertical detail and the proximity of the vertical component of the motion vector to a critical speed. However, there is still some evidence of similar effects when less demanding examples are examined.

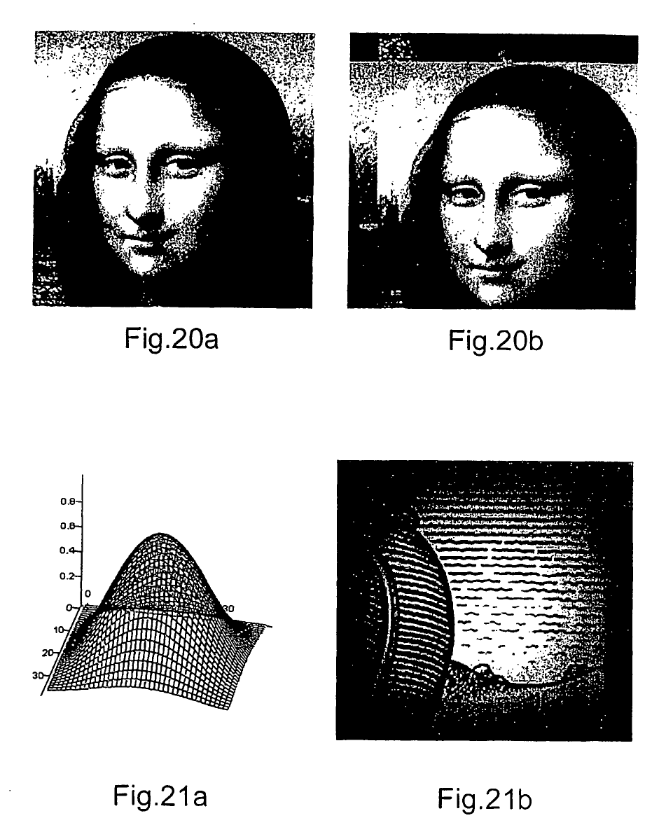

Assuming the motion vector being used to construct the filtered frame is non-zero, there is bound to be some distortion evident at the image edges. This is because picture content is effectively being shifted in from outside the image boundaries of the early and late fields, due to the process of compensating the motion in the image sequence. When an image is shifted by altering the phases of the frequency-domain components, the picture content introduced into one side is derived from the opposite side of the frame. In other words, the picture rotates around the frame, as illustrated by comparison of FIGS. 20a and 20b.

When an output image is constructed from several displaced input images, it, therefore, follows that irrelevant picture information will be introduced at the boundaries. This is unavoidable and limits the useful area of the resulting image; larger amounts of motion compensation causing more of the image to be unusable. The above shifted image also demonstrates the fact that, in frequency domain terms, the pixels on the left-hand edge of the original image are seen as neighbors of those on the right-hand edge, and similarly those on the top are effectively situated next to those on the bottom. Thus, in frequency terms, there are two hard edges in the picture that correspond to the vertical and horizontal boundaries whose step amplitudes depend on the differences between pixel values on opposite edges of the image. This introduces an irrelevant and undesirable feature into the description of the image in the frequency domain.

These effects are well known in connection with image processing and are generally overcome by the use of window functions. These are applied to the image effectively to hide the edges by softly fading the image detail down to some fixed level at the boundaries. When the window function is applied, little or no emphasis is given to image content near the tile boundaries. This applies both to the motion estimation and image reconstruction processes.

Various shapes of window function may be used. FIG. 21a shows by way of example, a simple two-dimensional raised cosine function applied as illustrated in FIG. 21b, to one of the earlier single-field images. More complex window functions may be used to form part of an arrangement of overlapping areas for analysis and interpolation, where the window function is also used to cross-fade between neighbouring areas to form the complete output image. The choice of the size of these overlapping areas and their general organization is necessarily a compromise between several conflicting requirements. The requirement to identify and accurately compensate motion vectors that vary across the picture suggests that the areas should be small, as does the observation that particular vectors can sometimes only be determined within a small ‘aperture’, as they are otherwise masked by the motion of more obvious objects. On the other hand, large motion vectors, that is to say, fast-moving objects, require large amounts of compensation and this greatly reduces the usable area of a picture tile, as already mentioned. There is a practical limit to the usefulness of a small area of analysis and interpolation, in respect of both functions. Fast-moving objects that move further than the area's dimensions in one input image period will certainly be missed altogether.

One approach to resolving this dichotomy is the use of more than one size of windowed tile. Larger tiles are useful where there are fast-moving objects and consistent vector fields. A larger format of tile may also be used to obtain ‘starter’ vectors at regular intervals, or when a scene change requires the vector list to be re-initialized. These ‘starter’ vectors may then be used to define the positions of smaller tiles in successive input images, so that the tile trajectories approximately track the motion of moving objects. Although this gives rise to an irregular array of windowed tiles within each output image, the output array may still be summed to form a complete frame by modulating each output pixel's gain to compensate for the combined window function weighting at the pixel's position.

As an alternative to an irregular array of tiles, a fixed array may be used with some limitations. In either case, the window function that is applied must be sufficiently limited in extent to ensure that any shifted images created in the interpolation process do not extend beyond the tile edges. Any such component of the interpolated image will rotate around the tile as shown in the earlier examples and will, therefore, be placed in an invalid position in the final image. Because the active area of each tile is limited in this way, it becomes necessary to overlay several offset arrays of tiles so that there are no gaps in coverage.

In the case of a fixed array, any motion will cause the image to spread in the direction of motion in the interpolated output tile. For a dynamically placed array, the image will spread only to the extent that the final vector differs from the first approximation used to define the tile trajectory.

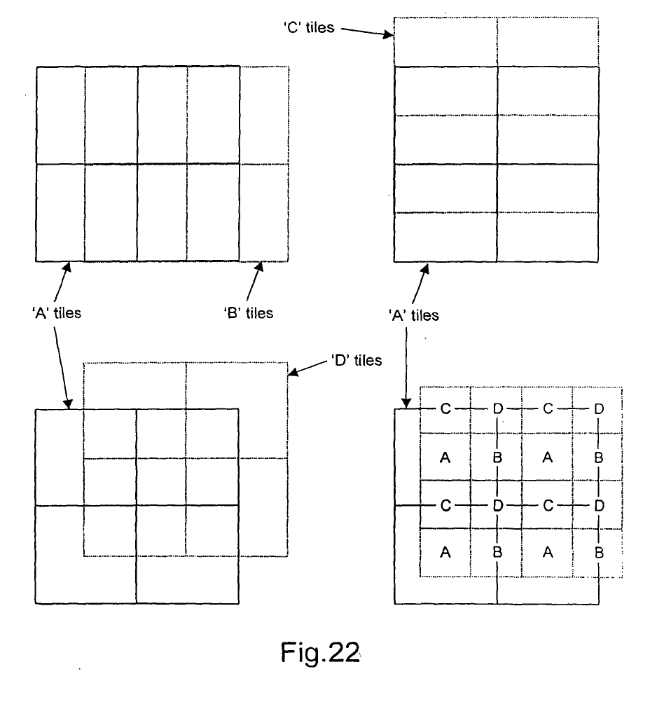

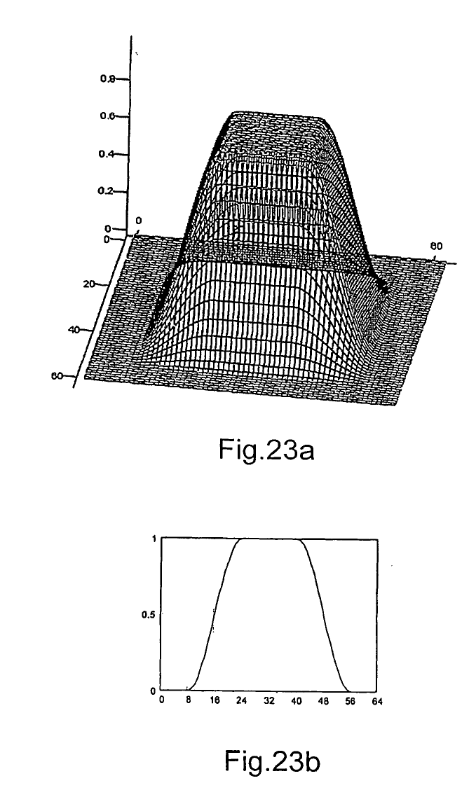

FIG. 22 shows four overlaid tile arrays with the tile sets labelled A, B, C and D. Owing to the window function, each tile effectively contributes only to the centre quarter of the tile's area, as shown more precisely in FIG. 23a; the window profile is also shown in one dimension in FIG. 23b. As shown in FIG. 22 the four offset tile sets allow the entire frame to be covered. The transition between each tile's center contributing area and its neighbor's contributing area is not a hard dividing line, as suggested in the diagram, but is in fact a soft transition. The transition function is defined by the shape of the window function of FIGS. 23a and 23b.

The window function must be chosen such that, when the value of the functions is summed for all the tiles in all the arrays, the result is constant at unity. In other words, the neighboring window functions must all fit together in two dimensions in a complementary fashion. Assuming for the moment that a fixed tile set is used and the entire picture content is stationary, it should be apparent that the four tile sets will create a complete, valid output image when summed. However, when the image sequence contains motion, each tile will attempt to compensate a local motion vector, effectively combining shifted input contributions from, for example, three input fields.

Although the motion may be compensated, the window function that was applied to each of the contributing tiles will also be shifted by the compensation vector, thereby fragmenting the result. Effectively, there are several windowed contributions, where the windows are offset from each other by the value of field motion vector.

This is of no consequence when the same motion vector is applied to all the tiles in the frame, since all the shifted contributions from one particular input field will still fit together as complementary functions. However, when the vectors are inconsistent in neighboring tiles, the neighboring contributions are weighted with relatively displaced window functions and require pixel-by-pixel gain adjustment to restore unity gain throughout the area.

If dynamically placed tiles are used, further pixel-by-pixel gain adjustments are required to allow the array of tiles to be combined into a valid output image. The dynamic array requires additional management, since the tile density is highly variable. It is necessary to add and delete tiles throughout an image sequence to maintain the density at the appropriate level in all areas of the output image. However, there is no limit to the magnitude of the vectors that may be compensated, assuming an approximation to the vector can be found in the first place. It is also possible to use wider window functions, thereby reducing the amount of overhead associated with transforming blanked data.

In the case of the static array, there is a limit to the magnitude of the compensating vectors that may be employed. Referring to the window function illustrated above, it is only permissible to shift a contributing field image by one-eighth of a tile width or height, to avoid shifting the windowed area outside of the tile boundaries. In the case shown, this limits the maximum displacement to ±8 lines vertically and ±8 pixels horizontally, which, in the case of the three-field aperture, limits the motion vector to ±8 lines vertically per field and ±8 pixels horizontally per field. If ‘early’ and ‘late’ three-field interpolation is included, the maximum permissible vectors are reduced even further, as the un-shifted field is no longer central. This is an unacceptably small range of vector amplitudes, and although this range may be extended by using further sets of fixed tiles, the scheme described above using dynamically-placed tiles is preferred.

The filtering process used to create full-resolution frames, as so far described, applies the same type of temporal frequency filter to all spatial frequency components. It is found in practice that interpolation performance may be improved by using two different filter types, with different sets of coefficients. The first set is derived as described above and is used for vertical frequencies with an absolute value greater than, say, 10% of the maximum. The second set is used for the lowest 10%. In reality, one set is ‘crossfaded’ into the other so that no abrupt switching between them occurs.

The second set of coefficients does not attempt to reject any particular temporal frequency, but passes the expected ‘baseband’ temporal frequency with unity gain, all other frequencies being relatively attenuated. The justification for using these simplified coefficients for these vertical frequencies is that the vertical spectrum found in most sources of interlaced video rolls off at a point somewhat lower than the ‘frame Nyquist’ frequency supported by the full-frame vertical sampling rate.

This means that the alias frequencies that would otherwise be found at vertical frequencies close to zero are, in many cases, not actually present. There is, therefore, little point in trying to remove them, particularly if through doing so, the interpolator performance becomes degraded. The high vertical frequencies (above 90% of maximum) can also be attenuated for the same reason.

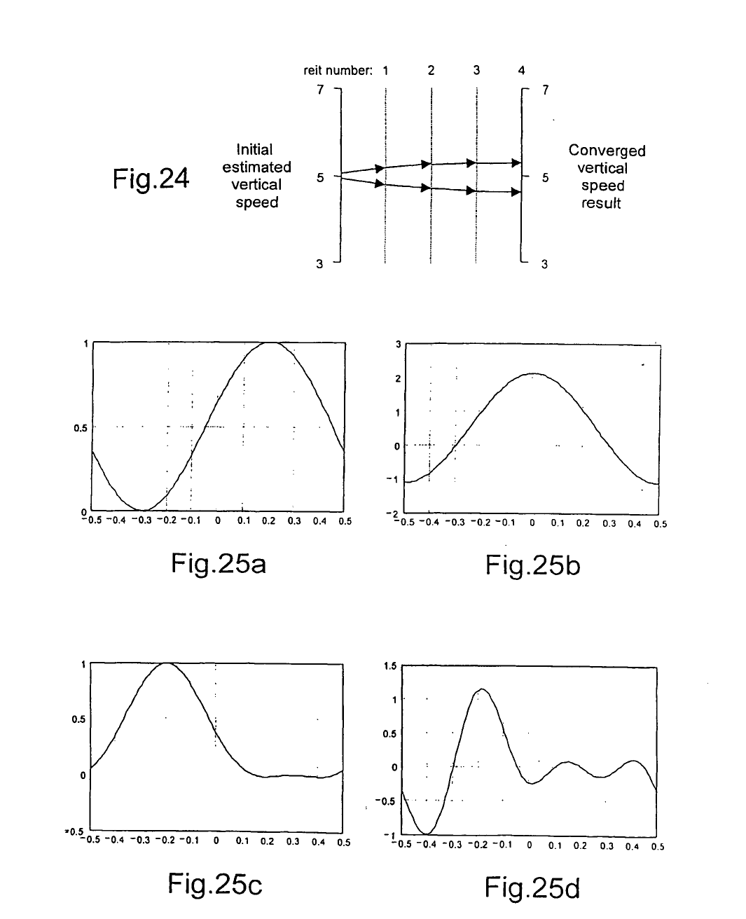

Although the reiterative motion estimation process will generally converge to an accurate result, it is found that some tiles' motion vectors can sometimes converge to two different solutions. When this occurs, it is found that the vertical components of the two solutions for the vector are situated close to, and roughly equal distances above and below a critical speed. If the initial phase correlation result is above the critical speed, the higher solution will usually be found and if it is below, the process will normally converge on the lower solution; an example is shown in FIG. 24. At first sight, this seems an anomaly, but further analysis reveals why this effect occurs.

When an image moves vertically at a rate close to one of the critical speeds and three-field interpolation is used, it is effectively scanned with tightly-packed groups of three lines, spaced at field scanning pitch. Even when six fields are used for analysis, the six effective lines may still not extend far enough to cover much of the space between the field scanning lines. The detail contained in the image between these bunched sets of lines must, therefore, be rebuilt by interpolation, but the interpolation can be accurately done only if accurate motion vectors are known. Initially, it is known only that the vertical motion speed is close to a particular critical value. The reiterative process should converge to the true solution and then an inverse transform of the interpolated frame(s) will yield a good approximation to the true image. However, a somewhat different image moving vertically at the alternative rate discussed above, may also provide a feasible solution. This different image contains the same information in each of its three effective scan lines in each group, but the group of lines is assumed to describe the detail in reverse order because of the opposite motion offset from the critical value. When these ‘alternative’ images are viewed, they are sometimes visually feasible because the human observer cannot decide which is the ‘true’ one; on other occasions, the observer can easily tell which is correct and which is wrong owing to knowledge of what real-world objects look like.

The problem seems to exist because of the need to interpolate from these very localized fields and at first seemed a serious limitation. However, it has been noted that when the converged values are compared, the ‘true’ solution often converges to a vertical speed that is further from the local critical value than the corresponding ‘phantom’ solution. This observation allows an algorithm to be developed that, in most cases, selects the correct solution before terminating the process.

The reiterative process described above provides motion vector values that converge to either the ‘true’ or ‘phantom’ solutions. Convergence is indicated when a further iteration causes a change in the vertical component of the motion vector that is less than some threshold value. When this occurs, the vertical component is replaced by a value that is equidistant from, but the other side of the local critical value. A further reiteration is used to establish whether the solution is ‘real’ or ‘phantom’ by testing to see if the next solution moves closer to, or further from the critical value. If it moves further from the critical value, then the final iteration is the solution, but if it moves nearer then the penultimate iteration is used. The ‘flipped’ vertical component algorithm need only be applied when the solution is found to be relatively close to a critical value. This algorithm has been empirically derived and its theoretical basis is not known.

The reiterative filtering process as described above, may also be used to remove other undesirable signal components whilst still providing the de-interlacing and motion-estimation functions. One such application is the decoding of a composite color video signal coded in accordance with the PAL or NTSC standards, or their variants, into three component signals.

In the latter respect, the PAL and NTSC standards use quadrature modulation of a subcarrier signal to convey two channels of information relating to the color content of the picture. It is generally recognized that the process of color decoding is very difficult to perform satisfactorily, the process involving the separation of the composite video signal into its luminance (Y) and chrominance (C) components and the demodulation of the modulated subcarrier to yield color difference signals. These two operations may be done in either order.

Many different schemes have been devised over many years to provide improved color decoding facilities. Although the PAL and NTSC color standards were conceived as analogue transmission formats and are nearing the end of their lives, there exists a wealth of archive material that has been recorded in these standards and now requires conversion into digital formats. The efficiency of the conversion process and the quality of the compressed digital result are impaired by the presence of undesirable signal components that remain due to imperfect PAL or NTSC decoding. The digital compression process may be considerably assisted by providing a better-decoded input signal and further aided if this input signal is presented in a de-interlaced (progressive) format.

The Y/C separation process has been carried out at varying levels of sophistication in the past. The simplest method is a one-dimensional low-pass or notch filter that separates the horizontal frequency spectrum into luminance and chrominance frequency bands. The next level of improvement uses a two-dimensional comb filter, which includes contributions from neighboring scan lines to allow the filter to differentiate between signal components on the basis of vertical frequency.

However, it is generally recognized that complete separation of the Y and C components can only be obtained from a ‘three-dimensional’ design, that is to say, one which also includes contributions from several neighboring input fields. Such decoders can be shown to produce perfect results when stationary coded input images are decoded, but start to fail when there is any image motion. This is caused by the inconsistency of information within the image sequence.

Some types of decoder revert to the two-dimensional or one-dimensional modes in response to local motion; a technique known as motion adaption. This represents a compromise solution for moving images, since few real picture sequences are completely devoid of motion, although the motion may be small. Unfortunately, using simple motion adaptive techniques, it is very difficult to determine the speed of motion and so there is a tendency for the smallest amount of motion in the image to cause the decoder to switch to a simple mode. What is really needed is the ability to decode a moving image as though it were stationary, and this is possible only when motion-compensated techniques are used.

The temporal frequency filtering technique described herein may be extended to accept or reject signal components relating to luminance and chrominance (Y/C) components. This provides a Y/C separation process that can be carried out on either the composite (Y+modulated subcarrier) signal, or on the demodulated color difference signals which include ‘cross color’ components due to interfering high-frequency luminance.

The process of motion-compensated interpolation described herein also possesses the useful property of reducing random noise in the input signal. This occurs because the combined images reinforce due to the consistency of their content, whereas there is generally no correlation between the noise found in each separate input image. As is the case with de-interlacing and color decoding, it is relatively straightforward to reduce the noise in a stationary image. However, extending the process to the more general case of moving images represents a major step in difficulty, particularly when the input image sequence is presented in an interlaced format.

Many existing noise-reducers are ‘motion adaptive’ designs, these adapting their mode of operation according to the presence or absence of detected motion. However, as in the case of adaptive color decoding, it is difficult to make a smooth transition between the two modes and, more importantly, the temporal redundancy in the image sequence cannot be exploited once the ‘moving’ mode is entered. The use of an accurate multi-field interpolation process, such as that described herein, allows stationary and moving picture detail to be treated in exactly the same way, consequently with the same degree of noise reduction.

The color decoding, noise reduction and de-interlacing processes may be used in any combination and the output images may be portrayed at any arbitrary intermediate point in time, as is required when converting between field or frame rates.

The form of one possible three-coefficient set for three-field interpolation, as described above, is:

$$[ \begin{matrix}B ( {f}_{b} , {f}_{a} ) \cdot exp ( j \cdot 2 π \cdot {f}_{p k} ( {f}_{b} , {f}_{a} ) ) \\ A \\ B ( {f}_{b} , {f}_{a} ) \cdot exp ( - j \cdot 2 π \cdot {f}_{p k} ( {f}_{b} , {f}_{a} ) )\end{matrix} ]$$

The frequencies f_{b} and fₐ are respectively those temporal frequencies to be passed and rejected.

It may be shown that the response of such a filter to an arbitrary temporal frequency, f_{sig}, takes the form of the following expression, shown graphically in FIG. 25a:

resp_{—}3f(f_{sig})=A+2.B. cos [2π(f_{sig}−fₚₖ)]

The value of A, the center coefficient is for example, 0.5. In the case shown in FIG. 25a, the value of fₚₖ is 0.2 and B is 0.25. The f_{sig} axis extends from −0.5 cycles per field to +0.5 cycles per field. Owing to the cyclic nature of the frequency spectrum, these two extreme frequencies are in fact the same (Nyquist frequency).

As seen in FIG. 25a, the peak response occurs when:

f_{sig}=fₚₖ

which, in this example, is where f_{sig} is 0.2.

If all that is required is to pass one temporal frequency and reject a second frequency that is situated 0.5 cycles per field higher or lower, then this can easily be accomplished by setting fₚₖ to the value of f_{b}. However, in the more general case, the two frequencies are not so conveniently situated. The value of fₚₖ may then be made equal to an offset average of f_{b} and fₐ, placing these two frequencies equidistant from and on either side of the point of highest slope in the sinusoidal response. FIG. 25b shows the overall response when the requested pass frequency, f_{b} is 0.2 and the requested rejection frequency, fₐ is 0.3.

The two frequencies are passed and rejected as required, but to fit this requirement using a simple sinusoidal function causes the response to swing over a large range at other frequencies; in this case, the fit has been achieved by setting fₚₖ to 0.5 and B to −0.809. As the two frequencies become closer together, the value of B has to become very large to fit the pass or stop requirement. However, the resulting large peak responses are undesirable and it is better to acknowledge the impossibility of this requirement by limiting the value of B and adjusting fₚₖ in order to pass both frequencies at close to 50% amplitude. This may be done as part of the coefficient table pre-calculation procedure.

The modified filter coefficients used for the lower vertical frequencies implement a filter with a specified pass frequency, but no specified rejection frequency. This type of filter may easily be realized by setting fₚₖ to the value of f_{b} and B to 0.25, giving a response as in the first example. The coefficients then have the following simpler form:

$$[ \begin{matrix}0.25 \cdot exp ( j \cdot 2 π \cdot {f}_{b} ) \\ 0.5 \\ 0.25 \cdot exp ( - j \cdot 2 π \cdot {f}_{b} )\end{matrix} ]$$

It is possible to interpolate any number of fields by the method disclosed herein by applying a set of interpolation coefficients of suitable size. Using the three-field approach shown above with a fixed centre coefficient, only two parameters; fₚₖ and B are used to specify the outer two coefficients. Therefore, in general, the response may only be defined at two frequencies. It is also sometimes necessary to be able to define the response at more than two frequencies. For example, in the case of combined de-interlacing and color decoding of the composite PAL signal, it is a requirement that one pass frequency and five stop frequencies may be specified, although constraints apply that allow the six frequencies to be specified by only four variables.

Suitable responses may be obtained using larger apertures, although the larger aperture, that is to say using more than three fields, is only applied to the chrominance band of high horizontal frequencies for the decoder application. A logical starting point is a five-field aperture with the general form:

$$[ \begin{matrix}C \cdot exp ( j \cdot 2 π \cdot 2 {f}_{P k} ) \\ B \cdot exp ( j \cdot 2 π \cdot {f}_{P k} ) \\ A \\ B \cdot exp ( - j \cdot 2 π \cdot {f}_{P k} ) \\ C \cdot exp ( - j \cdot 2 π \cdot 2 {f}_{P k} )\end{matrix} ]$$

The response associated with this form is:

A+2.B. cos [2π(f_{sig}−fₚₖ)]+2.C. cos [4π(f_{sig}−fₚₖ)]

The response shown in FIG. 25c is obtained when A is 0.34, B is 0.25, and C is 0.08.

As may be expected, adding more fields allows the response to be defined with greater precision. Using a very large number of fields, it would be possible to pass a narrow band of temporal frequencies and reject all others. However, it is not generally necessary or desirable to use a very large number of fields in the interpolator.

The filtering process associated with the color decoding application requires high-amplitude signal components at specific frequencies to be rejected. One approach to meeting this requirement is to derive larger sets of multi-field coefficients by cascading several three-field filters.

Referring back to the general form of the three-field filter response, it is possible to define any two rejection frequencies by adjusting the values of fₚₖ and A, effective shifting the sinusoid horizontally and vertically to allow the zero crossings to be appropriately placed. The values of A and B may then be scaled (and possibly inverted) to pass one desired component at a third frequency with unity gain, subject to the limitations relating to closely-situated frequency points discussed above. In the case of the PAL composite decoding application, a total of six temporal frequencies are specified, five of which are to exhibit a zero response and the sixth a gain of unity, with no phase distortion. This requirement may be met by cascading three three-field filters, two of these filters each providing two of the ‘notch’ rejection frequencies with unity gain at the pass frequency, and the last providing the one remaining notch frequency, again with unity gain at the one pass frequency.

As an example, a single spatial frequency of a standard composite PAL signal possesses six signal components according to the table of temporal frequencies ft below.

TABLE

| Component | ft | Component | ft |
|---|---|---|---|
| U | +0.20 | Uᵢₙₜ | +0.45 |
| V | −0.30 | Vᵢₙₜ | −0.05 |
| Y | −0.15 | Yᵢₙₜ | +0.10 |

where: U denotes the signal component due to the color subcarrier modulated by the (B-Y) color difference signal; V denotes the signal component due to the color subcarrier modulated by the (R-Y) color difference signal; Y denotes the luminance signal; and the ‘int’ subscript refers to alias components that are present due to the effects of interlaced scanning.

The various temporal frequencies may be selected as frequency pairs for each filter section in various ways. In the following example the three sections are designed on the basis of the frequency pairs associated with the U, V and Y PAL signal components respectively. The de-interlaced Y signal is the one component passed by the filter in this example, and the overall response of the three cascaded sections is as shown in FIG. 25d.

Referring to the above table of frequencies, it may be seen that the response requirements have all been met, although there is a further undesirable response lobe where f_{sig} is −0.4. The overall response is necessarily a compromise, since the proximity of pass and stop frequencies will always present a problem. It is possible to prioritize certain stop frequencies in some cases, when it is known that some of the frequency components are likely to have greater amplitudes than others, thereby optimizing the overall response shape.

In practice, the filtering operation would not be conducted as three separate steps, each using a three-field filter, but would be combined into one single filter.

In this case, the same result may be achieved by constructing a set of seven-field coefficients that may be derived from the three three-field sets.

The Y, U and V signal components of a composite color signal, as defined above, represent the luminance and two chrominance components of that signal, respectively. The seven-field filter described above may be used to recover the de-interlaced baseband Y signal, although the simpler three-field filter may be used for the Y signal at low horizontal frequencies, since this part of the spatial frequency spectrum has little or no chrominance energy present.

The de-interlaced U and V signals that are recovered from the filtering process are still modulated by the color subcarrier signal and so need to be demodulated before the baseband B-Y and R-Y signals can be recovered. This can either be done while in the frequency domain or, alternatively, by demodulating and filtering the inverse-transformed spatial domain results using standard techniques.

If the composite color signal is horizontally sampled at a rate related to the color subcarrier's horizontal frequency, then the demodulation process is easily carried out in the frequency domain. However, if sampled at the common standard rate of 13.5 MHz, the demodulation process becomes more involved, requiring complex interpolation of the frequency arrays to demodulate at the horizontally unrelated frequency.

In an alternative configuration of the color decoder, it is possible to demodulate the composite input signal to yield (B-Y) and (R-Y) baseband signals before any forward DFT transforms are performed. In this case, the (B-Y) and (R-Y) signals so derived will be contaminated with ‘cross-color’ due to the presence of luminance components within the chrominance part of the horizontal frequency spectrum. The composite input signal, the (B-Y) and (R-Y) signals may then all be transformed into three separate frequency arrays for filtering with suitable sets of seven-field coefficients. The filtering operation on the composite input signal allows the removal of modulated chrominance components, leaving the luminance signal. The corresponding filtering operations on the (B-Y) and (R-Y) signals allow the removal of the ‘cross-color’ components from these signals. The filters also provide de-interlaced arrays when returned to the spatial domain, as in the first configuration.

In either configuration, the reiterative motion estimation and compensation process described, is performed on luminance data only. Initially, the only luminance data available is found in the composite color signal, which also contains subcarrier-modulated chrominance components. These modulated components can only be completely removed after the filtering process has been applied and the filtering process, in turn, requires accurate motion vectors for it to work successfully. Therefore, the initial motion estimation has to be carried out using the composite signal after it has passed through a simple low-pass or notch filter to remove the part of the horizontal frequency spectrum corresponding to the chrominance band. After reasonably accurate vectors are found, an increasing proportion of the filtered high-frequency luminance result from the previous iteration may be added to the low-passed signal, providing greater accuracy in further iterations.

1. A method for motion-compensated filtering of a sequence of input images, wherein the images are transformed into representations in a frequency-domain in which spatial-frequency components are represented in amplitude and phase, weighting coefficients are applied to corresponding spatial-frequency components of successive image-representations, and the resultant weighted components are submitted after combination together to the inverse transform to derive filtered, output images in the spatial domain.

2. A method according to claim 1 wherein the weighting coefficients used for each spatial-frequency component are calculated as a function of the respective spatial frequency and a motion vector of the input images.

3. A method according to claim 1 or claim 2 wherein the filtering of the sequence of images and a process of motion estimation dependent upon interpolation from images of said sequence, are carried out together in dependence upon one another reiteratively in the frequency domain towards refinement of the output images.

4. A method according to claim 1 or claim 2 wherein the step of combining said resultant weighted components involves summing the frequency-domain representations of the corresponding spatial-frequency components within a predetermined group of successive images after application of the weighting coefficients to those representations individually, such as to derive therefrom an array of weighted frequency-domain components representative of the spatial-frequency components of an output image.

5. A method according to claim 4 wherein the group comprises three image fields.

6. A method according to claim 4 or claim 5 wherein the frequency-domain representations of said array are submitted to phase correlation with corresponding frequency-domain representations of a second said array derived from weighted and summed spatial-frequency components of a second, later group of successive images of said sequence, for deriving estimates of motion vectors of the images.

7. A method according to claim 6 wherein the estimates of motion vectors are utilised to derive further weighting coefficients for application to the spatial-frequency components of the respective images of the two groups of images to derive therefrom more-accurate arrays of frequency-domain representations of images of the two groups.

8. A method according to claim 7 wherein the derivation of said more-accurate arrays is repeated a predetermined number of times or is repeated until a predetermined convergent condition is attained, towards refinement of frequency-domain representation of the images before the inverse transformation to the spatial domain.

9. A method according to any one of claims 1 to 8 wherein the Spatial-frequency components of the images are represented as complex numbers in the frequency domain, and the weighting coefficients are complex numbers that are applied to the spatial-frequency components by multiplication.

10. A method according to any one of claims 1 to 9 wherein the input image sequence comprises a sequence of interlaced fields.

11. A method according to claim 10 wherein alias frequency components contained within the individual fields of the input image sequence are filtered out from inclusion in the output images by attenuation of temporal-frequency components associated with the respective spatial frequency and motion vector.

12. A method according to any one of claims 1 to 11 wherein the input image sequence contains modulated colour-signal and/or random-noise components and the weighting coefficients are such that these components are filtered out from inclusion in the output images.

13. Apparatus for motion-compensated filtering of a sequence of input images, wherein the images are transformed into representations in a frequency-domain in which spatial-frequency components are represented in amplitude and phase, weighting coefficients are applied to corresponding spatial-frequency components of successive image-representations, and the resultant weighted components are submitted after combination together to the inverse transform to derive filtered, output images in the spatial domain.

14. Apparatus according to claim 13 wherein the weighting coefficients used for each spatial-frequency component are calculated as a function of the respective spatial frequency and a motion vector of the input images.

15. Apparatus according to claim 13 or claim 14 wherein the filtering of the sequence of images and a process of motion estimation dependent upon interpolation from images of said sequence, are carried out together in dependence upon one another reiteratively in the frequency domain towards refinement of the output images.

16. Apparatus according to claim 13 or claim 14 wherein means for performing the step of combining said resultant weighted components involves means for summing the frequency-domain representations of the corresponding spatial-frequency components within a predetermined group of successive images after application of the weighting coefficients to those representations individually, such as to derive therefrom an array of weighted frequency-domain components representative of the spatial-frequency components of an output image.

17. Apparatus according to claim 16 wherein the group comprises three image fields.

18. Apparatus according to claim 16 or claim 17 wherein the frequency-domain representations of said array are submitted to phase correlation with corresponding frequency-domain representations of a second said array derived from weighted and summed spatial-frequency components of a second, later group of successive images of said sequence, for deriving estimates of motion vectors of the images.

19. Apparatus according to claim 18 wherein the estimates of motion vectors are utilised to derive further weighting coefficients for application to the spatial-frequency components of the respective images of the two groups of images to derive therefrom more-accurate arrays of frequency-domain representations of images of the two groups.

20. Apparatus according to claim 19 wherein the derivation of said more-accurate arrays is repeated a predetermined number of times or is repeated until a predetermined convergent condition is attained, towards refinement of frequency-domain representation of the images before the inverse transformation to the spatial domain.

21. Apparatus according to any one of claims 13 to 20 wherein the spatial-frequency components of the images are represented as complex numbers in the frequency domain, and the weighting coefficients are complex numbers that are applied to the spatial-frequency components by multiplication.

22. Apparatus according to any one of claims 13 to 21 wherein the input image sequence comprises a sequence of interlaced fields.

23. A method according to claim 22 wherein alias frequency components contained within the individual fields of the input image sequence are filtered out, from inclusion in the output images by attenuation of temporal-frequency components associated with the respective spatial frequency and motion vector.

24. Apparatus according to any one of claims 13 to 23 wherein the input image sequence contains modulated colour-signal and/or random-noise components and the weighting coefficients are such that these components are filtered out from inclusion in the output images.
